(19) United States
(12) Patent Application Publication
(10) Pub. No.: US 2023/0318170 A1
(43) Pub. Date: Oct. 5, 2023

(54) VEHICLE ANTENNA DEVICE

(71) Applicant: HARADA INDUSTRY CO., LTD., Tokyo (JP)

(72) Inventor: Yutaka IMAMURA, Shinagawa-ku, Tokyo (JP)

(21) Appl. No.: 17/918,888

(22) PCT Filed: Apr. 15, 2020
(86) PCT No.: PCT/JP2020/016630

§ 371 Date: Oct. 13, 2022

(51) Int. Cl. H01Q 1/32; H01Q 21/30; H01Q 1/52

(52) U.S. Cl. CPC H01Q 1/3275; H01Q 21/30; H01Q 1/526

(57) ABSTRACT

A vehicle antenna device is configured to provide effective noise shielding, and to have a reduced thickness. The vehicle antenna device includes a first element and a second element. The first element functions as a capacitive antenna and supports a first frequency band. The second element functions as a resonant antenna and is disposed at a position capable of shielding noise from a noise source to the first element and shields the noise. The second element supports a second frequency band higher than the first frequency band. An attenuator circuit attenuating a signal of the first frequency band may be connected to the second element.

### CROSS-REFERENCE TO RELATED APPLICATIONS

This application is a U.S. national stage application of International Application No. PCT/JP2020/016630, filed on Apr. 15, 2020.

### BACKGROUND

### Technical Field

The present invention relates to a vehicle antenna device, and more particularly to a vehicle antenna device with improved noise immunity.

### Background Information

A pillar antenna, roof-mounted antenna, and glass antenna are among the antenna devices that are mounted on a vehicle to support a plurality of frequency bands, or, for example, the antenna devices that support AM/FM bands. However, the pillar antenna, which protrudes greatly, is at high risk of being bent by contact or any other trouble. The roof-mounted antenna needs to be folded or removed in such places as a multistory car park and an automatic car-washing machine because of a higher ground clearance. The problem with the glass antenna is that the antenna involves a specific development for each vehicle model, leading to higher development and production costs and the like. Then, in recent years, there is a so-called shark-fin antenna, which is an antenna device with small size and low-profile. Further, since there is growing demand for the vehicle-mounted antenna devices that do not ruin the appearance of vehicles as much as possible, various spoiler antennas that could be built inside a spoiler have been developed so that the appearance is not ruined (e.g., Patent Document 1).

Noise from electronic devices and the like disposed in a vehicle is not a big issue for the shark-fin or roof mount antenna which is mounted on the vehicle roof so long as the roof body is made from metal, because the noise can be shielded by the vehicle roof. However, the spoiler antenna, unlike the case in which the antenna is mounted on the vehicle roof, is installed in an upper portion of the rear glass at the periphery of the vehicle roof, and therefore, the noise shielding effects of the vehicle roof cannot be expected. Currently available vehicle antenna devices ensure market conformity and practicality in terms of the noise level of the FM frequency band antenna, but the noise level of the major AM frequency band antennas is intolerable, and hens the other noise countermeasures are separately required. There also exists Japanese Patent Application No. 2018-172263 which was filed by the same applicant as the present application for aiming to shield the noise from inside a vehicle. This is the antenna providing a shielding plate between a shared antenna element for AM/FM frequency bands and a noise source inside a vehicle.

### SUMMARY

The invention disclosed in the aforementioned patent application filed by the same applicant for the present application has a high level of noise shielding effect; however, due to the use of the shielding plate for obtaining shielding effects, the antenna device becomes unavoidably large in size compared to those that have no shielding plate. In addition, particularly in view of the sensitivity in the FM frequency band, the shared antenna element for AM/FM frequency bands and the shielding plate must secure a certain distance, specifically about 30 mm, from each other, thus, the antenna device is required to take predetermined measures for the sensitivity in the FM frequency band in case of applying a use of needing of reducing thickness.

The present disclosure has been made in view of the above circumstances, and the object thereof is to provide a vehicle antenna device that provides effectiveness in noise shielding and can be reduced in thickness.

To achieve the above object of the present disclosure, the vehicle antenna device according to the present disclosure may include: a first element that functions as a capacitive antenna and supports a first frequency band; and a second element that functions as a resonant antenna and supports a second frequency band higher than the first frequency band, the second element being disposed at a position capable of shielding noise from a noise source to the first element and shielding the noise.

Further, the vehicle antenna device may also include an attenuator circuit that is connected to the second element and attenuates a signal of the first frequency band.

Also, the first element may have a plate-like body, and the second element may also have a plate-like body having a larger area than the first element.

Further, the vehicle antenna device may include a first filter circuit that is connected to the first element and passes a signal of the first frequency band therethrough.

Further, the vehicle antenna device may include a second filter circuit that is connected to the second element and passes a signal of the second frequency band therethrough.

Also, the first element may support an AM wave band and the second element may support an FM wave band.

Further, the vehicle antenna device may include a resonant coil that is connected to the second element and makes the second element tune to a signal of the second frequency band.

Further, the vehicle antenna device may include a plurality of resonant coils that are connected to the second element and make the second element tune to signals of multiple frequency bands.

Further, the vehicle antenna device may include a circuit board on which an amplifier circuit for amplifying a signal of the first frequency band and/or a signal of the second frequency band is placed.

Here, the circuit board may be disposed between the first element and the second element.

Further, the vehicle antenna device may include a third element that functions as a patch antenna and supports a third frequency band.

Here, the third element may be disposed between the first element and the second element, and the first element may include a waveguide part for the third element.

Further, the vehicle antenna device may include a fourth element that functions as a dipole antenna and uses the second element as a part thereof so as to support a fourth frequency band higher than the second frequency band.

Further, the vehicle antenna device may include a fifth element that functions as a dipole antenna and uses the first element as a part thereof so as to support a fourth frequency band higher than the second frequency band.

Also, the second element may have a bracket profile so as to be fixed to a resin part of a vehicle.

Further, the vehicle antenna device may include a sixth element that is disposed close to a side of the first element and supports a fifth frequency band, wherein the second element may be disposed at a position capable of shielding noise from a noise source to the first element and the sixth element and shields the noise.

Further, the vehicle antenna device may include an attenuator circuit that is connected to the second element and attenuates a signal of the first frequency band and a signal of the second frequency band.

Further, the vehicle antenna device may include a sixth element that is disposed close to a side of the second element and supports a fifth frequency band, wherein at least one of the second element and the sixth element may be disposed at a position capable of shielding noise from a noise source to the first element and shields the noise.

Further, the vehicle antenna device may include an attenuator circuit that is connected to the sixth element and attenuates a signal of the first frequency band.

The vehicle antenna device according to the present disclosure has the advantages of providing effectiveness in noise shielding and capable of being reduced in thickness.

### BRIEF DESCRIPTION OF THE DRAWINGS

Referring now to the attached drawings which form a part of this original disclosure.

FIG. 1 is a schematic perspective view for explaining an overview of a vehicle antenna device according to one illustrated embodiment.

FIG. 2 is a schematic perspective view for explaining an example in which the shielding effects of the vehicle antenna device according to the illustrated embodiment are enhanced.

FIG. 3 is circuit diagrams for explaining examples of an attenuator circuit used in the vehicle antenna device according to the illustrated embodiment.

FIG. 4 is a schematic perspective view for explaining a specific example of the vehicle antenna device according to the illustrated embodiment.

FIG. 5 is a schematic perspective view for explaining another specific example of the vehicle antenna device according to the illustrated embodiment.

FIG. 6 is a schematic perspective view for explaining another example of the vehicle antenna device according to the illustrated embodiment.

FIG. 7 is a schematic perspective view for explaining another example of the vehicle antenna device according to the illustrated embodiment.

FIG. 8 is a schematic perspective view for explaining another example of the elements of the vehicle antenna device according to the illustrated embodiment.

FIG. 9 is a schematic perspective view for explaining another example of the elements of the vehicle antenna device according to the illustrated embodiment.

FIG. 10 is a schematic perspective view for explaining still another example of the elements of the vehicle antenna device according to the illustrated embodiment.

FIG. 11 is a schematic perspective view for explaining an example of the elements constituted by a latticed element of the vehicle antenna device according to the illustrated embodiment.

### DETAILED DESCRIPTION OF EMBODIMENTS

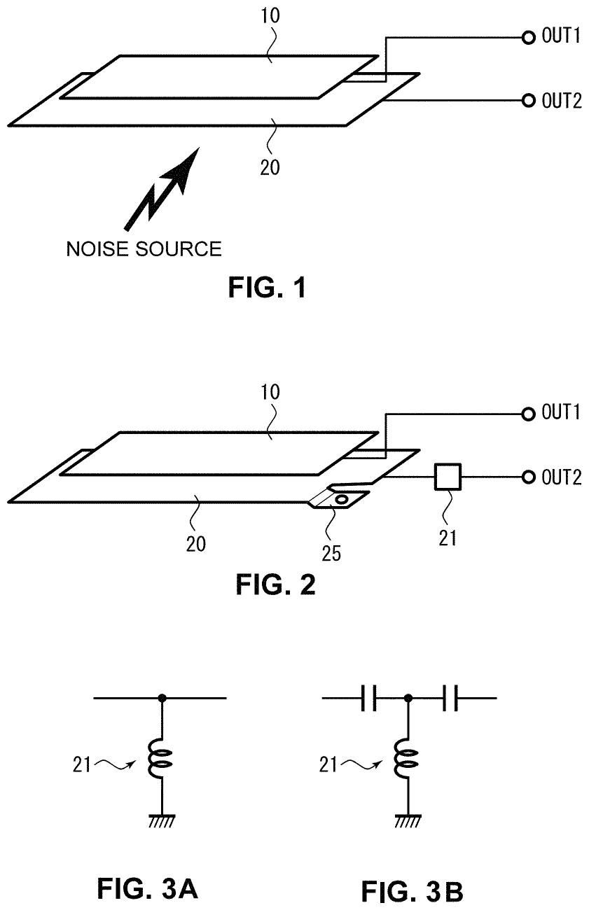

Hereinafter, an embodiment for practicing the present invention will be described with reference to the accompanying drawings. FIG. 1 is a schematic perspective view for explaining an overview of a vehicle antenna device according to the an illustrated embodiment. As illustrated, the vehicle antenna device according to the illustrated embodiment is mainly constituted by a first element 10 and a second element 20. The vehicle antenna device according to the illustrated embodiment is explained in detail below.

The first element 10 is constituted by a capacitive antenna that supports a first frequency band. The first frequency band may be, for example, the AM frequency band of the radio. The capacitive antenna is a so-called capacity-loaded antenna element. The first element 10 has a plate-like body in the illustrated example. Specifically, for example, the first element 10 may have a flat plate-like conductive body of about 30 mm×170 mm adapted for the AM frequency band. The present invention, however, is not limited thereto, and may be umbrella-shaped instead of the flat shape so long as it functions as a capacity-loaded antenna element that has an antenna capacity substantially equivalent to that of a solid pattern. Further, many different kinds of shapes like meanders, spiral and space-filling curve are also applicable to the present invention. It should be noted here that when slits are formed to create meanders, it is preferable that their gap be small enough with respect to the wavelength of the first frequency band.

The second element 20 is a resonant antenna that supports a second frequency band that is higher than the first frequency band. The second frequency band may be, for example, the FM frequency band of the radio. The element length of the second element 20 should be adjusted so as to function as a resonant antenna. The illustrated example of the second element 20 has a plate-like body. Specifically, for example, the second element 20 may have a flat plate-like conductive body of about 50 mm×180 mm adapted for the FM frequency band. As will be described later, when the element length is not long enough to support the FM band, a resonant coil may be provided separately. The most distinctive feature of the present invention is that the second element 20 has a noise shielding function by being disposed at a position capable of shielding noise from a noise source to the first element. For example, when the noise source is a high mount stop lamp, the second element 20 may be disposed between the first element 10 and the high mount stop lamp. Here, as long as the second element 20 shields noise from the noise source, the second element 20 may not necessarily be larger than the first element 10 depending on the positional relationship among the noise source, the first element 10 and the second element 20. Nonetheless, so long as the second element 20 has a larger area than the first element 10, the second element 20 can be made to have the shielding function for other types of noise emitted from multiple noise sources as well. Additionally, the second element 20 will be able to shield noise more efficiently when it is positioned perpendicular to an expected major noise source. In this view, the first element 10 and the second element 20 may not necessarily be positioned in parallel. Further, the second element 20 may not necessarily have a flat plate-like body, and can have a semicylindrical, concave or V shape so as to cover the rear surface of the first element 10 or so as to fit the form of the installation position of the second element 20. The illustrated example of the second element 20 has a plate-like body. The present invention, however, is not limited thereto; many other kinds of shapes like meanders, spiral and space-filling curve are also applicable to the present invention so long as the second element 20 can provide a noise shielding function. It should be noted here that when slits are formed to create meanders, it is preferable that their gap be small enough with respect to the wavelength of the first frequency band, so that the second element 20 can provide the noise shielding function.

The position relationship of the first element 10 and the second element 20 may appropriately be fixed by using an insulative support member, a resin part of the casing of the vehicle antenna device, or the like.

In the vehicle antenna device according to the present invention having the above configuration, the distance between the first element 10 and the second element 20 can be reduced. That is, although the second element 20 is disposed close to the first element 10, since the first element 10 is non-grounded, a small distance between them is not a big problem that could affect the sensitivity of the second element 20. Thus, for the vehicle antenna device according to the present invention, the distance between the first element 10 and the second element 20 can be decided only considering the the sensitivity of the first element 10. Specifically, for example, for the AM/FM frequency bands, a tolerable sensitivity can be obtained for each of the first element 10 and the second element 20 when the distance is about 10 mm.

As described above, the vehicle antenna device according to the present invention can be reduce in thickness while supporting multiple frequency bands by using the second element 20 as an element for the FM frequency band while the second element 20 has a noise shielding function for the first element 10 for the major AM frequency band, i.e., the first frequency band, which is intolerable noise level. This arrangement therefore makes it possible to easily install the vehicle antenna device according to the present invention in a thin space, such as, e.g., a spoiler of a vehicle.

The vehicle antenna device according to the present invention uses the first element 10 as an element for the AM frequency band and the second element 20 as an element for the FM frequency band, allowing them to be independent of each other. Thus, unlike the case of using the existing shared antenna element for AM/FM frequency bands, an isolation circuit for separating the AM signal and the FM signal is no longer required. This can eliminate a signal loss due to the isolation circuit and thus improve the antenna characteristics as a whole.

Next, a technique of enhancing the shielding effects of the second element 20 for the first element 10 is described below. FIG. 2 is a schematic perspective view for explaining an example in which the shielding effects of the vehicle antenna device according to the present invention are enhanced. In the drawings, the same reference numerals as those in FIG. 1 denote the same parts. In the illustrated example, the second element 20 that has a bracket profile 25 so as to be fixed to a resin member, such as a resin part of a vehicle or a resin part of the casing of the vehicle antenna device is shown. Specifically, for example, the bracket profile 25 is formed by such as cutting and bending the second element 20. This is intended that the second element 20 can directly be fixed to the resin member with a screw or the like when the vehicle antenna device according to the present invention is mounted on a resin member such as a resin-made rear door or spoiler. The present invention, however, is not limited thereto; as described above, it may have any other configuration so long as it functions as a capacity-loaded antenna element that has an antenna capacity substantially equivalent to that of a solid pattern.

As shown in FIG. 2, the second element 20 is connected to an attenuator circuit 21 for attenuating a signal of the first frequency band corresponding to the first element 10. Herewith, among noise emitted from noise sources, a noise signal in the first frequency band is attenuated through the attenuator circuit 21 connected to the second element. Therefore, the second element 20 reliably has a noise shielding function with respect to the first element 10.

The attenuator circuit 21 may attenuate a signal of the first frequency band. Specifically, the attenuator circuit 21 can be, e.g., a noise filter circuit shown in FIG. 3. FIG. 3 is circuit diagrams illustrating examples of an attenuator circuit for use in the vehicle antenna device according to the present invention, in which FIG. 3(a) shows a short circuit and FIG. 38(b) shows a high-pass filter circuit. For example, when the short circuit shown in FIG. 3(a) is used as the attenuator circuit 21, a signal of the first frequency band flows to the ground side through a coil. Herewith, a noise signal from a noise source for the first element 10 is grounded to the ground, allowing the signal of the first frequency band to be short-circuited and a signal of the second frequency band to flow to the output terminal OUT2 side. Also, when the high-pass filter circuit shown in FIG. 3(b) is used as the attenuator circuit 21, the filter circuit may be designed such that a signal of the first frequency band lower frequency band than the second frequency band flows to the ground side through a coil. Herewith, a noise signal from a noise source for the first element 10 is grounded to the ground, allowing the signal of the second frequency band higher frequency band than the first frequency band to flow to the output terminal OUT2 side. That is, the signal of the first frequency band that reaches the second element 20 is grounded to the ground. Herewith, the noise signal in the first frequency band is reliably attenuated. Although the illustrated example is the attenuator circuit 21 connected in series to the output terminal OUT2 of the second element 20, the present invention is not limited thereto, and the coil grounded to the ground may be directly connected to the second element 20 as the attenuator circuit 21. Additionally, the attenuator circuit 21 may be constituted simply by inserting a capacitor in series to the output terminal OUT2. Inductance and capacitance are optionally adjusted in tune with the frequency band.

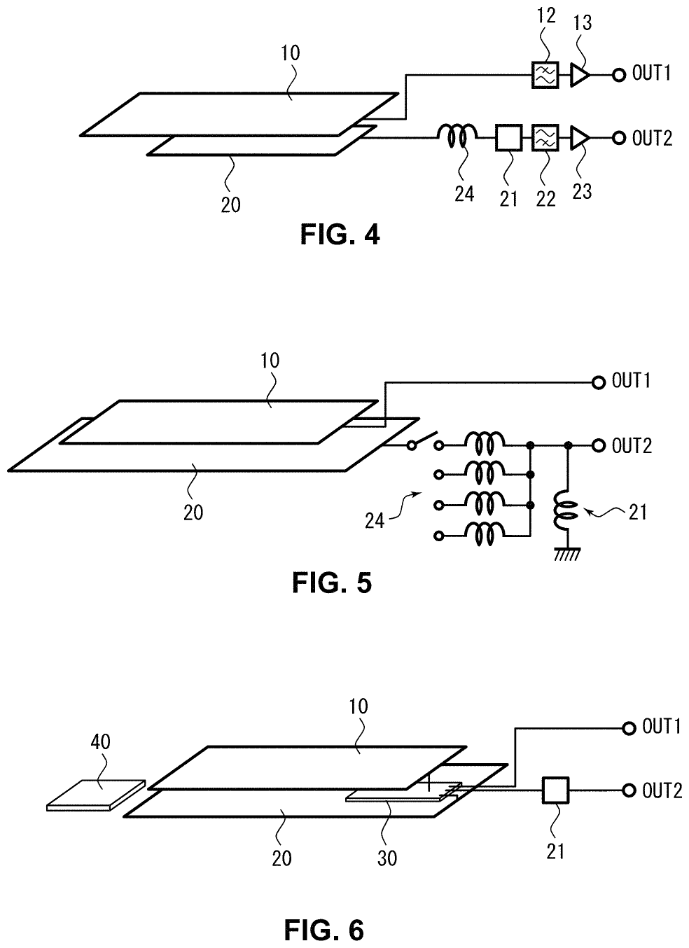

Further, a specific example of the vehicle antenna device according to the present invention will be described with reference to FIG. 4. FIG. 4 is a schematic perspective view for explaining a specific example of the vehicle antenna device according to the present invention. In the drawings, the same reference numerals as those in FIG. 2 denote the same parts. As illustrated, the vehicle antenna device according to the present invention may further have a first filter circuit 12. The first filter circuit 12 is connected to the first element 10. The first filter circuit 12 passes a signal of the first frequency band therethrough. Specifically, the first filter circuit 12 may be, e.g., a low-pass filter circuit. The first filter circuit 12 is inserted to an output terminal OUT1 in series so that only the signal of the first frequency band is output to the output terminal OUT1. Herewith, since the signal of, for example, the second frequency band can be made not to flow to the output terminal OUT1 side, it is possible to improve the isolation between the first element 10 and the second element 20. Thus, even if the first element 10 and the second element 20 are disposed close to each other, sensitivity degradation caused by interference in their frequency bands can be prevented. In the drawings, an example where the second element 20 can be made smaller than the first element 10 depending on the positional relationship among the noise source, the first element 10 and the second element 20; nonetheless, the second element may be larger than the first element, as in the above-illustrated example.

Further, the vehicle antenna device according to the present invention may additionally have a second filter circuit 22. The second filter circuit 22 passes a signal of the second frequency band therethrough. Specifically, the second filter circuit 22 may be, e.g., a high-pass filter circuit. The second filter circuit 22 is inserted to the output terminal OUT2 in series so that only the signal of the second frequency band is output to the output terminal OUT2. Herewith, since the signal of, for example, the first frequency band can be made not to frow to the output terminal OUT2 side, it is possible to further improve the isolation between the first element 10 and the second element 20. Thus, even if the first element 10 and the second element 20 are disposed close to each other, sensitivity degradation caused by interference in their frequency bands can be prevented. Incidentally, the attenuator circuit 21 may also be used as the second filter circuit 22.

Further, as in the illustrated example, an amplifier circuit 13 for amplifying a signal of the first frequency band and an amplifier circuit 23 for amplifying a signal of the second frequency band may be provided. The amplifier circuits 13 and 23 may be used to amplify received signals.

Further, in the example illustrated in FIG. 4, it is shown that the second element 20 is connected to a resonant coil 24. The resonant coil 24 is used to make the second element 20 tune to a signal of the second frequency band. The resonant coil 24 is used to adjust the reactance when the element length is not long enough for tuning to the signal of the second frequency band, and herewith, the second element 20 becomes tunable to the signal of the second frequency band.

Further, as shown in FIG. 5, the resonant coil 24 may be constituted by a plurality of selectively connectable coils. FIG. 5 is a schematic perspective view for explaining another specific example of the vehicle antenna device according to the present invention. In the drawings, the same reference numerals as those in FIG. 4 denote the same parts. As illustrated, in the vehicle antenna device according to the present invention, a plurality of resonant coils 24 may be connected to the second element 20 so as to make the second element 20 tune to signals of multiple frequency bands. In the illustrated example, a switch is used to selectively connect to one of the plurality of the resonant coils 24. This structure allows the second element 20 to tune to not only a signal of the second frequency band but also signals of other frequency bands.

FIG. 6 is a schematic perspective view for explaining another example of the vehicle antenna device according to the present invention. In the drawings, the same reference numerals as those in FIG. 1 denote the same parts. As illustrated, the vehicle antenna device according to the present invention has a circuit board 30. For example, on the circuit board 30, the amplifier circuits 13 and 23 may be mounted to amplify signals of the first frequency band and the second frequency band. Also, on the circuit board 30, the attenuator circuit 21, the resonant coil 24, the first filter circuit 12, the second filter circuit 22 and the like may be mounted.

Then, as in the illustrated example, the circuit board 30 may be disposed between the first element 10 and the second element 20. The distance between the first element 10 and the second element 20 can make a certain space because they are spaced apart to such a degree as to avoid capacitive coupling. In the vehicle antenna device according to the present invention, the circuit board 30 is disposed by using such space. Herewith, since an area for placing the circuit board 30 does not need to be provided separately, a vehicle antenna device having an area corresponding to that of the first element 10 and the second element 20 can be achieved. Thus, the vehicle antenna device according to the present invention can be downsized while having noise shielding effects.

Further, an additional element such as a patch antenna may be provided as illustrated. That is, a third element 40 which is a patch antenna may be provided. The third element 40 may support a third frequency band. The third element 40 may be, for example, a dielectric patch antenna using a circularly polarized wave and having a ceramic. Specifically, this may be a patch antenna for GPS, GLONASS, SDARS or the like that has resonant frequency in, e.g., UHF band. As a matter of course, the third element 40 may be employed not only for the example of FIG. 6 but also for those of the other illustrated examples of the present invention. As above, the vehicle antenna device according to the present invention can be constituted to support further multiple frequency bands.

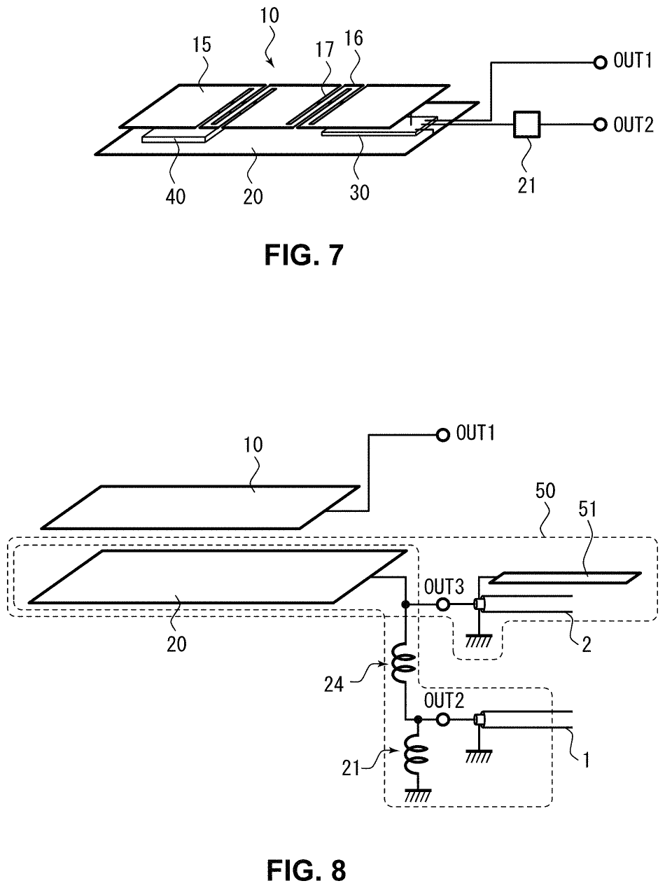

Next, an example will be described with reference to FIG. 7, in which a patch antenna as disclosed in Japanese Patent Application Kokai Publication No. 2018-121143 by the applicant identical to that of the present application is added to the vehicle antenna device according to the present invention. FIG. 7 is a schematic perspective view for explaining another example of the vehicle antenna device according to the present invention. In the drawings, the same reference numerals as those in FIG. 1 denote the same parts. As illustrated, the vehicle antenna device according to the present invention is an example in which the third element 40 being a patch antenna is further provided. Such third element 40 is disposed between the first element 10 and the second element 20. The first element 10 has a waveguide part 15 for the third element 40. The waveguide part 15 refers to a substantially square conductive planar body portion that functions also as a wave director for the third element 40. The gain of the third element 40 can be improved by providing the waveguide part 15 even if the third element 40 is disposed between the first element 10 and the second element 20. In the illustrated example, the waveguide part 15 is formed by the rectangular first element 10 electrically divided into a plurality of substantially square conductive planar bodies as viewed from the third element 40 by using stubs 16. Each stub 16 is formed in a zigzag pattern constituted by a plurality of slits 17 in the first element 10 in a staggered manner so that currents flow in such directions as cancelling each other out. Thus, by providing the plurality of staggered slits 17, the current directions become the directions canceling each other out at the periphery of the slits 17 provided. Herewith, the first element 10 behaves, in the third frequency band, e.g., the UHF band, of the third element 40, as a plurality of substantially square blocks separated. Herewith, since an area for placing the third element 40 does not need to be provided separately, a vehicle antenna device having an area corresponding to that of the first element 10 and the second element 20 can be achieved. Thus, it is possible to downsize while having the noise shielding effects. Meanwhile, other specific examples of the waveguide part are described in Japanese Patent Application Kokai Publication No. 2018-121143 by the applicant identical to that of the present application; therefore, a detailed description thereof is omitted herein.

Next, an example will be described with reference to FIG. 8, in which a dipole antenna as disclosed in Japanese Patent Application No. 2018-136488 by the applicant identical to that of the present application is added to the vehicle antenna device according to the present invention. FIG. 8 is a schematic perspective view for explaining another example of the elements of the vehicle antenna device according to the present invention. In the drawings, the same reference numerals as those in FIG. 1 denote the same parts. This example is that the vehicle antenna device according to the present invention is applied to an element-shared composite antenna device. The element-shared composite antenna device is formed enable to receive signals of multiple frequency bands by also using one element of a dipole antenna as a monopole antenna, too. As illustrated, the vehicle antenna device according to the present invention in this example further has a fourth element 51 that is a part of a dipole antenna 50 using the second element 20 as a part thereof, so as to support a fourth frequency band that is higher than the second frequency band. Like the above example as illustrated, the second element 20 as a monopole antenna is a resonant antenna that supports the second frequency band, which may be, for example, the FM frequency band of the radio. Although the example is illustrated that the resonant coil 24 making the second element 20 tune to a signal of the second frequency band is connected in series to the output terminal OUT2, the resonant coil 24 can be omitted so long as the element length is long enough for a signal of the second frequency band. The inner conductor of the coaxial cable 1 is connected to the output terminal OUT2 and the outer conductor thereof is grounded to the ground. The dipole antenna 50 is constituted to support the fourth frequency band that is higher than the second frequency band. The fourth frequency band is, for example, such a frequency band as a DTV (Digital Television) broadcasting frequency band. Incidentally, the frequency band supported by the dipole antenna 50 is not limited to the DTV frequency band, and may be a DAB (BAND III) frequency band. Further it may be mobile phone frequency bands. The dipole antenna 50 uses the second element 20 as a part thereof. That is, the second element 20 and the fourth element 51 constitutes the dipole antenna 50. An output terminal OUT3 branching off from the second element 20 is a feed part for the dipole antenna 50 and connected to the inner conductor of the coaxial cable 2. The outer conductor of the coaxial cable 2 is grounded to the ground. Further, the fourth element 51 is connected to the outer conductor of the coaxial cable 2. That is, of the two elements constituting the dipole antenna 50, the second element 20 to which the inner conductor of the coaxial cable 2 is connected is an element shared as a monopole antenna. Meanwhile, Japanese Patent Application No. 2018-136488 filed by the applicant identical to that of the present application illustrates the details of an element-shared composite antenna device; therefore, a detailed description thereof is omitted herein. The vehicle antenna device according to the present invention has also excellent antenna characteristics as a dipole antenna because the second element 20 has a certain large area when the second element 20 is, for example, an element for the FM frequency band.

Incidentally, in FIG. 8, although the example is illustrated where the second element 20 is used as a part of the dipole antenna 50, the present invention is not limited thereto, and the first element 10 may be used as a part of the dipole antenna. That is, the vehicle antenna device according to the present invention, as an element-shared composite antenna device, may further include a fifth element that is a part of the dipole antenna using the first element 10 as a part thereof, so as to support the fourth frequency band that is higher than the second frequency band. As explained above, the fourth frequency band may be, for example, such a frequency band as a DTV (Digital Television) broadcasting frequency band. The vehicle antenna device according to the present invention has also excellent antenna characteristics as a dipole antenna because the dipole antenna is disposed above the second element 20 when the first element 10 is, for example, an element for the AM frequency band.

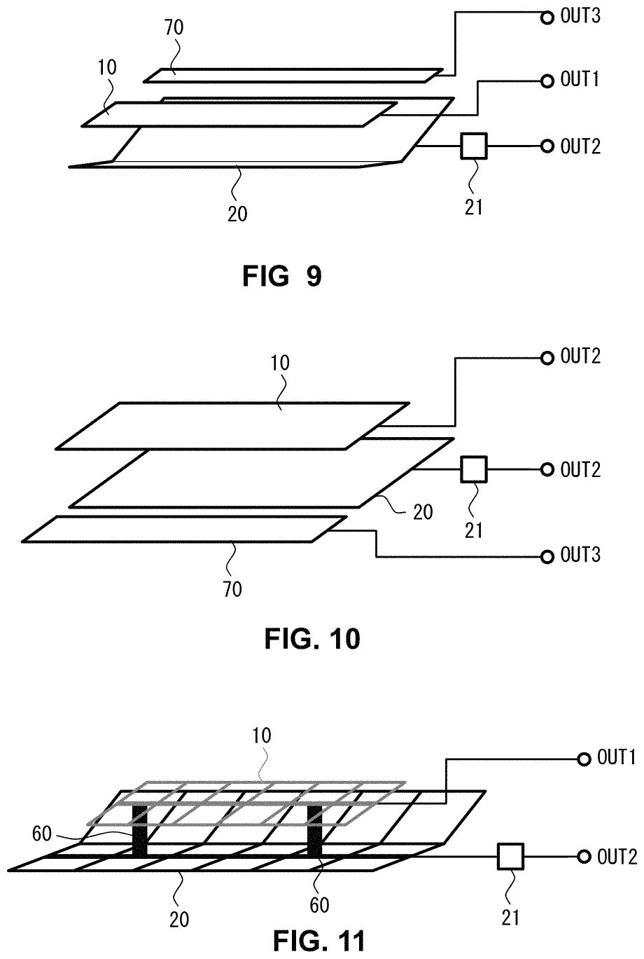

Next, another example of the elements of the vehicle antenna device will be described with reference to FIG. 9. FIG. 9 is a schematic perspective view for explaining another example of the elements of the vehicle antenna device according to the present invention. In the drawings, the same reference numerals as those in FIG. 1 denote the same parts. In this example, a sixth element 70 is added to the above-illustrated example. The sixth element 70 may support a fifth frequency band. The fifth frequency band may be, for example, a frequency band for a TEL. The sixth element 70 is adjusted in length so that it functions as a resonant antenna. Incidentally, when the element length is not long enough, the reactance may be adjusted using a coil or the like as appropriate. As illustrated, the sixth element 70 may be disposed close to a side of the first element 10. The second element 20 is disposed at a position capable of shielding the first element 10 and the sixth element 70 from noise originating from noise sources. In the illustrated example, although the sixth element 70 is disposed so as to be flush with the first element 10, the present invention is not limited thereto; they may be disposed in different heights or different plane angles. Also, the first element 10 and the sixth element 70 may not need to be in parallel with each other. Further, in the illustrated example, it is illustrated that the second element 20 is not a flat plate-like body but be bent forming a V-shape when viewed from the short side thereof. The present invention, however, is not limited thereto, and it may be a flat plate-like body like those of the above-illustrated examples so long as it has a noise shielding function.

Also, the attenuator circuit 21 connected to the second element 20 may attenuate a signal of the first frequency band and/or a signal of the fifth frequency band. Herewith, the noise shielding effects of the second element 20 for the first element 10 and/or the sixth element 70 can be enhanced.

Also, another example of the elements of the vehicle antenna device according to the present invention will be described with reference to FIG. 10. FIG. 10 is a schematic perspective view for explaining another example of the elements of the vehicle antenna device according to the present invention. In the drawings, the same reference numerals as those in FIG. 1 denote the same parts. In this example, the sixth element 70 is added to the above-illustrated examples of FIGS. 1 and 2. The sixth element 70 may support a fifth frequency band. The fifth frequency band may be, for example, a frequency band for TEL. The element length of the sixth element 70 is adjusted so that the sixth element 70 functions as a resonant antenna. Incidentally, when the element length is not long enough, the reactance should be adjusted using a coil or the like as appropriate. As illustrated, the sixth element 70 is disposed close to a side of the second element 20. Then, at least one of the second element 20 and the sixth element 70 may be disposed at a position capable of shielding noise from a noise source to the first element 10. In the illustrated example, although the sixth element 70 is disposed so as to be flush with the second element 20, the present invention is not limited thereto; they may be disposed in different heights or different plane angles. Also, the second element 20 and the sixth element 70 may not need to be in parallel with each other. Further, the second element 20 or the sixth element 70 may be bent forming a V-shape when viewed from the short side thereof.

In the illustrated example, the example is illustrated that the attenuator circuit 21 is connected to the second element 20 for enhancing the shielding effects of the second element 20. However, the present invention is not limited thereto; when the sixth element 70 is disposed for having the shielding effects for the first element 10, an attenuator circuit for attenuating a signal of the first frequency band may be connected to the sixth element 70. Herewith, the shielding effect of the sixth element 70 for the first element 10 can be enhanced. Also, attenuator circuits may be connected to both the second element 20 and the sixth element 70.

As described above, the vehicle antenna device according to the present invention can comprise the first element 10 and the second element 20 configured into various types of shapes, including meanders, spiral, and space-filling curve. In FIG. 11, the element formed into a latticed element is illustrated as an example. FIG. 11 is a schematic perspective view for explaining an example of the elements constituted by a latticed element of the vehicle antenna device according to the present invention. In the drawings, the same reference numerals as those in FIG. 1 denote the same parts. As illustrated, the first element 10 and the second element 20 are respectively formed into a lattice (mesh) shape using conductor wires. The space between the first element 10 and the second element 20 may be fixed by using, for example, insulative support members 60 as appropriate. This arrangement can reduce the weight of the antenna elements more effectively than using flat plate-like conductors. Incidentally, although both the first element 10 and the second element 20 are formed in a latticed element in the illustrated example, the present invention is not limited thereto; as a matter of course, the latticed element may be applied to only one of them. Also, although the second element 20 in the illustrated example is bent forming a V-shape when viewed from the short side thereof, it may be a flat shape.

The vehicle antenna device according to the present invention is not limited to the above illustrative examples but may be variously modified without departing from the scope of the present invention.

### REFERENCE SIGNS LIST

1: Coaxial cable
2: Coaxial cable
10: First element
12: First filter circuit
13: Amplifier circuit
15: Waveguide part
16: Stub
17: Slit
20: Second element
21: Attenuator circuit
22: Second filter circuit
23: Amplifier circuit
24: Resonant coil
25: Bracket profile
30: Circuit board
40: Third element
50: Dipole antenna
51: Fourth element
60: Support member
70: Sixth element

1. A vehicle antenna device to be installed on the roof of a vehicle, the vehicle antenna device comprising:
a first element that functions as a capacitive antenna and supports a first frequency band; and
a second element that functions as a resonant antenna and supports a second frequency band higher than the first frequency band, the second element being disposed at a position capable of shielding noise from a noise source to the first element and shielding the noise.

2. The vehicle antenna device according to claim 1, further comprising
an attenuator circuit that is connected to the second element and attenuates a signal of the first frequency band.

3. The vehicle antenna device according to claim 1, wherein
the first element has a plate-like body, and the second element has a plate-like body having a larger area than the first element.

4. The vehicle antenna device according to claim 1, further comprising
a first filter circuit that is connected to the first element and passes a signal of the first frequency band therethrough.

5. The vehicle antenna device according to claim 1, further comprising
a second filter circuit that is connected to the second element and passes a signal of the second frequency band therethrough.

6. The vehicle antenna device according to claim 1, wherein
the first element supports the AM wave band and the second element supports the FM wave band.

7. The vehicle antenna device according to claim 1, further comprising
a resonant coil that is connected to the second element and makes the second element tune to a signal of the second frequency band.

8. The vehicle antenna device according to claim 1, further comprising
a plurality of resonant coils connected to the second element and makes the second element tune to signals of multiple frequency bands.

9. The vehicle antenna device according to claim 1, further comprising
a circuit board on which an amplifier circuit for amplifying a signal of the first frequency band and/or a signal of the second frequency band is placed.

10. The vehicle antenna device according to claim 9, wherein
the circuit board is disposed between the first element and the second element.

11. The vehicle antenna device according to claim 1, further comprising
a third element that functions as a patch antenna and supports a third frequency band.

12. The vehicle antenna device according to claim 11, wherein
the third element is disposed between the first element and the second element, and
the first element includes a waveguide part for the third element.

13. The vehicle antenna device according to claim 1, further comprising
a fourth element that functions as a dipole antenna and uses the second element as a part thereof so as to support a fourth frequency band higher than the second frequency band.

14. The vehicle antenna device according to claim 1, further comprising
a fifth element that functions as a dipole antenna and uses the first element as a part thereof so as to support a fourth frequency band higher than the second frequency band.

15. The vehicle antenna device according to claim 1, wherein
the second element has a bracket profile so as to be fixed to a resin part of a vehicle.

16. The vehicle antenna device according to claim 1, further comprising
a sixth element that is disposed close to a side of the first element and supports a fifth frequency band,
wherein the second element is disposed at a position capable of shielding noise from a noise source to the first element and the sixth element and shields the noise.

17. The vehicle antenna device according to claim 16, further comprising
an attenuator circuit that is connected to the second element and attenuates a signal of the first frequency band and/or a signal of the second frequency band.

18. The vehicle antenna device according to claim 1, further comprising
a sixth element that is disposed close to a side of the second element and supports a fifth frequency band,
wherein at least one of the second element and the sixth element is disposed at a position capable of shielding noise from a noise source to the first element and shields the noise.

19. The vehicle antenna device according to claim 18, further comprising
an attenuator circuit that is connected to the sixth element and attenuates a signal of the first frequency band.
